(19) United States
(12) Patent Application Publication
(10) Pub. No.: US 2016/0013943 A1
(43) Pub. Date: Jan. 14, 2016

(54) VERIFICATION METHOD APPLIED TO REMOTE CONNECTION AND RELATED VERIFICATION SYSTEM AND RELATED IP CAMERA

(71) Applicant: Vivotek Inc., New Taipei City (TW)

(72) Inventor: Tzu-Wei Huang, New Taipei City (TW)

(21) Appl. No.: 14/720,999

(22) Filed: May 26, 2015

(30) Foreign Application Priority Data
Jul. 14, 2014 (TW) 103124139

(51) Int. Cl. H04L 9/32; H04L 29/06; H04L 9/08

(52) U.S. Cl. CPC H04L 9/3213; H04L 9/0861; H04L 63/126

(57) ABSTRACT

A verification method applied to remote connection includes a server generating a first key and a second key matched with each other, an IP camera connecting to the server to acquire the first key, the server transmitting a token encrypted or signed by the second key to a first user program which successfully logins the server, the IP camera receiving a connection request with the token from a second user program, and the IP camera utilizing the first key to verify the token and responding the connection request according to a verification result.

### BACKGROUND OF THE INVENTION

1. Field of the Invention

The present invention relates to a remote-connecting verification method, and more particularly, to a verification method, a verification system and a related IP camera applied to remote connection for keep private information.

2. Description of the Prior Art

The internet protocol (IP) camera is connected to the server and the user can conveniently watch video information captured by the IP camera. The server stores network address and communication connecting port of every IP camera, the user can login the server to connect the selected IP camera and watch the video information of the selected IP camera. Safety protection of the server is important because the server stores necessary online information about the IP camera. The server needs to be secured by the system manager to forbid the malicious invader and prevent the online information stored inside the server from being stolen. The user not only fears that the online information stored inside the server is taken by the system manager who is permitted to login the server, but also fears that the physical server is stolen to search out the online information for connecting to the IP camera to peek the video information captured by the IP camera. Therefore, design of a verification technique applied to remote connection capable of protecting the online information, which is applied to connect the IP camera and stored inside the server, from being stolen by the malicious invader and/or the system manager is an important issue in the related industry.

### SUMMARY OF THE INVENTION

The present invention provides a verification method, a verification system and a related IP camera applied to remote connection for keep private information for solving above drawbacks.

According to the claimed invention, a verification method applied to remote connection is disclosed. The verification method includes a server generating a first key and a second key matched with each other, an internet protocol camera connecting to the server to acquire the first key, the server transmitting a token encrypted or signed by the second key to a first user program which successfully logins the server, the IP camera receiving a connection request with the token from a second user program, and the IP camera utilizing the first key to verify the token and responding the connection request according to a verification result.

According to the claimed invention, a verification system applied to remote connection is disclosed. The verification system includes a server, an internet protocol camera, a first user device and a second user device. The server is adapted to generate a first key and a second key matched with each other. The internet protocol camera is connected to the server to acquire the first key. The first user device is adapted to login the server so as to acquire a token encrypted or signed by the second key. The second user device is adapted to transmit a connection request with the toke to the IP camera. The IP camera utilizes the first key to verify the token and responses the connection request according to a verification result. An internet protocol camera that behaves the IP camera of the above-mentioned verification system is further discloses.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a verification system applied to remote connection according to an embodiment of the present invention.

FIG. 2 is a flow chart of a verification method applied to the remote connection according to the embodiment of the present invention.

### DETAILED DESCRIPTION

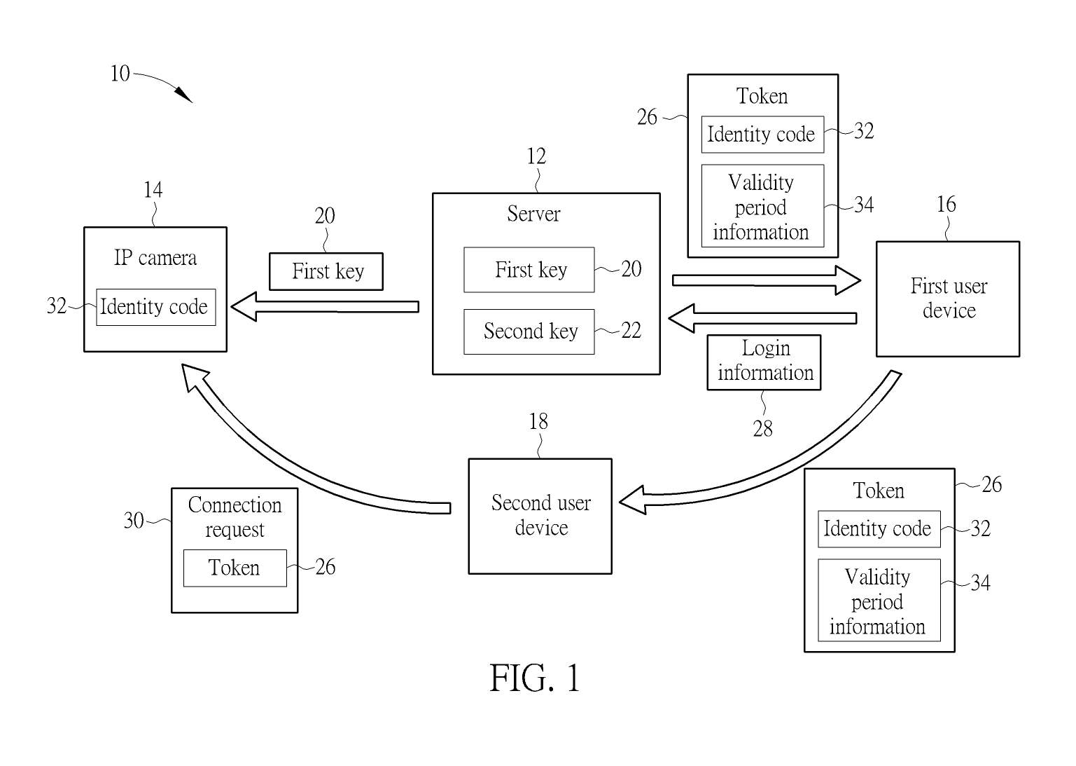

Please refer to FIG. 1. FIG. 1 is a functional block diagram of a verification system 10 applied to remote connection according to an embodiment of the present invention. The verification system 10 includes a server 12, an internet protocol (IP) camera 14, a first user device 16 and a second user device 18. The first user device 16 can be, but not limited to, a desktop computer, a notebook computer, a tablet computer, or a smart phone. The second user device 18 can be, but not limited to, the desktop computer, the notebook computer, the tablet computer, or the smart phone. The server 12 records an identity code 32 of the IP camera 14 registered by each user, and the identity code 32 may be a media access control address or the identity typical of the IP camera 14. The server 12 further records an IP address and at least one port of the IP camera 14. The IP camera 14 is an image capturing device that can transmit images by internet architecture. The first user device 16 and the second user device 18 can be connected to the IP camera 14 through the server 12 directly or indirectly, to acquire video data captured by the IP camera 14.

In procedures of the verification system 10, the server 12 generates a first key 20 and a second key 22 matched with each other. The first key 20 can be a public key based on a public key infrastructure, and the second key 22 can be a private key matched with the foresaid public key accordingly. The first key 20 and the second key 22 are not stored inside a nonvolatile memory (such as the hard disk) of the server 12. The first key 20 and the second key 22 are stored inside a volatile memory such as the dynamic random access memory (DRAM) and intermixed with other program codes and data, so as to increase crack difficulty of stealing the keys and to prevent the keys from being stolen by the unworthy server manager. The former keys are deleted and the new first key 20 and the second key 22 matched with each other are re-generated while the server 12 is restarted, to increase the crack difficulty by updating the keys. The server 12 may notify the IP camera 14 to re-download the first key 20 while the keys are updated, or the IP camera 14 may actively connect to the server 12 randomly or periodically to check whether to download the updated first key 20.

It should be mentioned that the verification system 10 can restart the server 12 or automatically update the keys according to a predetermined period, such as restarting the server 12 or updating the keys once per week. The verification system 10 further can restart the server 12 or automatically update the keys by a specific command periodically or randomly, such as restarting the server 12 or updating the keys in the midnight without the connection request. The verification system 10 further can restart the server 12 or automatically update the keys while the malicious invader is detected, for example, the firewall blocks the malicious attack and drives the server to restart or automatically update the keys. The foresaid specific command can be an artificial command (such as the restart command made by the user) or a mandatory command (such as the restart command due to an accidental power failure). The updating frequency and triggering factor of the keys are not limited to the above-mentioned embodiment, which depend on actual demand.

While or after the server 12 generates the first key 20 and the second key 22, the IP camera 14 connects the server 12 to acquire the first key 20. A first user program (such as the web browser) of the first user device 16 can be executed to connect the server 12 and access a login interface provided by the server 12, and logins the server 12 by login information 28 (which represents the pre-registering account and the password). The login interface can be a normal graphic webpage or any kinds of pages. The server 12 transmits a token 26 encrypted by the second key 22 to the foresaid first user program (such as the web browser of the first user device 16) which logins successfully. The token 26 may be an electronic document. The token 26 has the identity code 32 of the IP camera 14 which is registered by the login user. The token 26 also has validity period information 34. Then, the second user program of the second user device 18 is executed to transmit a connection request 30 with the token 26 to the IP camera 14. It should be noticed that the second user program can be the web browser identical with the first user program, or can be online software provided by the camera manufacturer different from the first user program. That is, the second user device 18 can be the same device as the first user device 16. As the second user device 18 and the first user device 16 are different, the user can transmit the token 26, which is received by the first user device 16, to the second user device 18 via transportation function (such as USB, Ethernet or WiFi) of the second user device 18. The IP camera 14 utilizes the first key 20 acquired from the server 12 to verify the token 26 from the second user program, for instance, the first key 12 is utilized to decrypt the token 26 or to verify its digital signature. The identity code 32 of the token 26 is checked whether to conform to the IP camera identity code, and then the current date and time are checked whether to conform to the validity period information 34 of the token 26. The connection request 30 is allowed and the user can watch the video data captured by the IP camera 14 while the above-mentioned checks are permitted, and the connection request 30 is refused while the above-mentioned checks are not permitted.

For example, the user can acquire the token 26 by the web browser (the first user program) of the personal computer (the first user device 16), the token 26 is transmitted from the first user device 16 to the smart phone (the second user device 18), and the application program (the second user program) of the smart phone (the second user device 18) transmits the connection request 30 with the token 26 to the IP camera 14 for obtaining the captured video data. In addition, the user can execute operation of acquiring the token 26 and making the connection request 30 simply all by the smart phone or all by the personal computer.

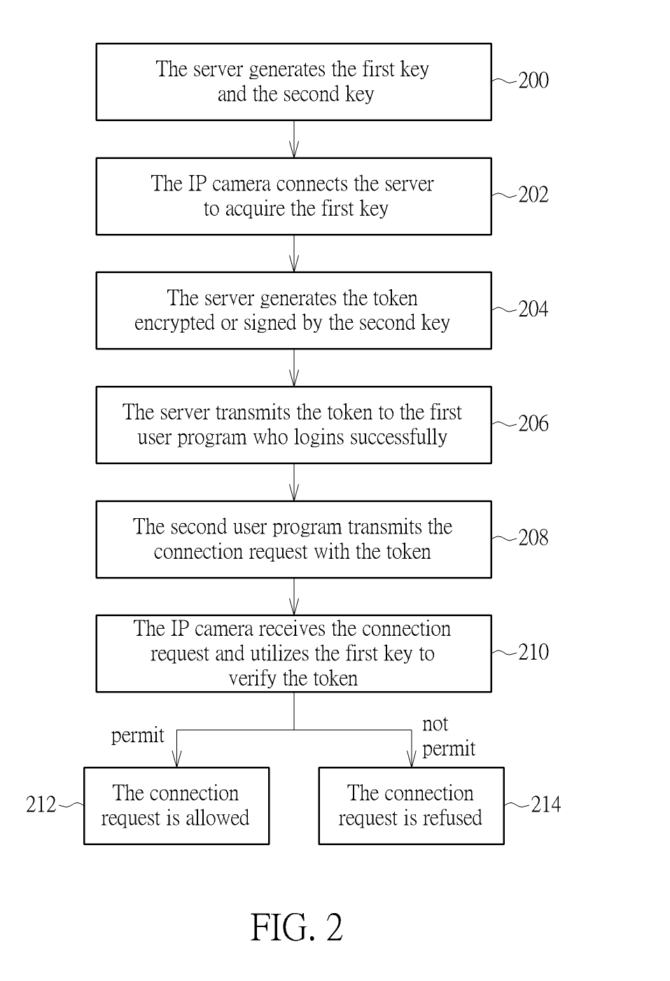

Please refer to FIG. 2. FIG. 2 is a flowchart of a verification method applied to the remote connection according to the embodiment of the present invention. The verification method illustrated in FIG. 2 is suitable for the verification system 10 shown in FIG. 1. First, step 200 is executed to generate the first key 20 and the second key 22 matched with each other by the server 12. In order to increase the crack difficulty and to prevent the keys from being stolen by the unworthy server manager, the server 12 may regenerate a new set of the first key 20 and the second key 22 randomly or periodically. Then, step 202 is executed that the IP camera 14 connects to the server 12 to acquire the first key 20. The IP camera 14 and the server 12 may establish connection randomly or periodically to transmit the updated first key 20 according to design demand. For example, the server 12 can automatically connect to the IP camera 14 while the keys are updated, and actively transmit the first key 20 to the IP camera 14. Or, the IP camera 14 may check whether the former-acquired first key 20 is valid while connecting to the server 12, and determine whether to download the updated first key 20.

Step 204 and step 206 are executed that the first user device (the first user program) logins the server 12 by the login information 28, the server 12 generates the token 26 that has the identity code 32 of the IP camera registered by the login account and the validity period information 34, and the token 26 is encrypted by the second key 22. The server 12 transmits the token 26 to the first user device 16 (the first user program). The IP camera identity code 32 represents the unique camera ID, such as the MAC address, of the corresponding IP camera 14, which means that each token 26 is valid for the specific IP camera 14. The validity period information 34 represents service life of the token 26 and normally corresponds to the updating period of the keys of the server 12, for example, the keys are updated once a week. The token 26 is invalid behind the service life, and the first user device 16 (the first user program) has to acquire the updated token 26.

Step 208 and step 210 are executed that the second user device 18 (the second user program) transmits the connection request 30 with the token 26 to the IP camera 14, and the IP camera 14 receives the connection request 30 and utilizes the first key 20 to verify the token 26. Step 212 is executed if the verification is permitted, the connection request 30 is allowed and the IP camera 14 can transmit the video data for the user according to content of the connection request 30. Step 214 is executed to refuse the connection request 30 if the verification is not permitted. In step 210, the IP camera 14 not only utilizes the first key 20 to decrypt the token 26 or to verify the digital signature of the token 26, but also determines whether the IP camera identity code 32 of the token 26 conforms to the own identity code 32. The connection request 30 is allowed when the IP camera identity code 32 of the token 26 conforms to the identity code 32 of the IP camera 14, and the connection request 30 is refused when the IP camera identity code 32 of the token 26 does not conform to the identity code 32 of the IP camera 14, so as to ensure that the connection request activates the correct IP camera. In addition, the IP camera 14 determines whether the current date and time of the received connection request 30 conforms to the validity period information 34 of the token 26. The connection request 30 is allowed when the current date and time of the received connection request 30 conforms to the validity period information 34 of the token 26, and the connection request 30 is refused when the current date and time of the received connection request 30 does not conform to the validity period information 34 of the token 26.

In conclusion, the server of the present invention can update the first key and second key randomly or periodically, the first key is preserved by the IP camera, the second key is utilized to encrypt or sign the token, and the token is transmitted to the user device (the user program) having login permission. The user device (the user program) can further transmit the connection request with the token to the IP camera, the token is decrypted or the digital signature of the token is verified by the first key of the IP camera, and the connection request from the user device (the user program) can be allowed or refused according to content of the token while decryption is successful or the verification is permitted. The verification method, the verification system and the related IP camera of the present invention can update the keys frequently and store the keys into indefinite position of memory in the server, the server manager and the malicious invader cannot falsify the token to steal the video data of the IP camera because the correct and valid keys are unavailable, and the video data of the IP camera is only watched by the user having the login information

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A verification method applied to remote connection, the verification method comprising:
a server generating a first key and a second key matched with each other;
an internet protocol (IP) camera connecting to the server to acquire the first key;
the server transmitting a token encrypted or signed by the second key to a first user program which successfully logins the server;
the IP camera receiving a connection request with the token from a second user program; and
the IP camera utilizing the first key to verify the token and responding the connection request according to a verification result.

2. The verification method of claim 1, wherein the IP camera comprises an identity code, and a step of the IP camera utilizing the first key to verify the token and responding the connection request according to the verification result comprises:
allowing the connection request while the IP camera determines that an IP camera identity code contained inside the token conforms to the identity code of the IP camera, or else the connection request is refused.

3. The verification method of claim 2, wherein the token further contains validity period information, and a step of the IP camera utilizing the first key to verify the token and responding the connection request according to the verification result comprises:
allowing the connection request while the IP camera determines that a current date and time conforms to the validity period information, or else the connection request is refused.

4. The verification method of claim 1, wherein the first key and the second key are stored inside a volatile memory of the server.

5. The verification method of claim 1, wherein the server updates the first key and the second key according to a predetermined period, or according to a command, or while a malicious invader is detected.

6. The verification method of claim 5, wherein the server automatically transmits the updated first key to the IP camera.

7. The verification method of claim 5, wherein the IP camera connects to the server to determine whether to download the updated first key.

8. A verification system applied to remote connection, the verification system comprising:
a server adapted to generate a first key and a second key matched with each other;
an internet protocol (IP) camera connected to the server to acquire the first key;
a first user device adapted to login the server so as to acquire a token encrypted or signed by the second key; and
a second user device adapted to transmit a connection request with the toke to the IP camera;
wherein the IP camera utilizes the first key to verify the token and responses the connection request according to a verification result.

9. The verification system of claim 8, wherein the IP camera allows the connection request while an IP camera identity code contained inside the token conforms to an identity code of the IP camera, or else the connection request is refused.

10. The verification system of claim 8, wherein the token further contains validity period information, the IP camera utilizes the first key to verify the token and allows the connection request while a current date and time conforms to the validity period information, or else the connection request is refused.

11. The verification system of claim 8, wherein the server comprises a volatile memory whereinside the first key and the second key are stored.

12. The verification system of claim 8, wherein the server updates the first key and the second key according to a predetermined period, or according to a command, or while a malicious invader is detected.

13. An internet protocol (IP) camera that behaves the IP camera of a verification system according to claim 8.
